(19) United States
(12) Patent Application Publication
(10) Pub. No.: US 2024/0202924 A1
(43) Pub. Date: Jun. 20, 2024

(54) IMAGE PROCESSING APPARATUS, IMAGE PROCESSING METHOD, AND IMAGE PROCESSING PROGRAM

(71) Applicant: FUJIFILM Corporation, Tokyo (JP)

(72) Inventor: Mizuki TAKEI, Tokyo (JP)

(73) Assignee: FUJIFILM Corporation, Tokyo (JP)

(21) Appl. No.: 18/537,688

(22) Filed: Dec. 12, 2023

(30) Foreign Application Priority Data
Dec. 20, 2022 (JP) 2022-203681

(51) Int. Cl. G06T 7/00; G06F 40/279

(52) U.S. Cl. CPC G06T 7/0014; G06F 40/279; G06T 2207/20081; G06T 2207/30004; G06T 2207/30176

(57) ABSTRACT

An image processing apparatus derives a degree of attention for each organ based on a content of a medical document, sets an execution condition of abnormality detection processing on a medical image according to the degree of attention for each organ, and executes the abnormality detection processing in accordance with the set execution condition.

### CROSS-REFERENCE TO RELATED APPLICATIONS

This application claims priority from Japanese Patent Application No. 2022-203681, filed on Dec. 20, 2022, the entire disclosure of which is incorporated herein by reference.

### BACKGROUND

### 1. Technical Field

The present disclosure relates to an image processing apparatus, an image processing method, and an image processing program.

### 2. Description of the Related Art

JP2015-011446A discloses a technique of extracting an examination item of examination data having an abnormal value based on examination data of a plurality of examination items, specifying a target of interest based on the extracted examination item, and analyzing a three-dimensional image of the target of interest.

### SUMMARY

An image interpreter has various purposes for interpreting a medical image, and a degree of attention of the image interpreter to each organ differs depending on a purpose, such as “searching for a lesion by focusing on a specific organ” and “searching for a lesion by observing the entire medical image widely”. That is, there may be an organ with a low degree of attention of the image interpreter depending on the purpose. In this case, there is a high possibility that an abnormality of the organ is overlooked. There is known a technique for supporting the image interpreter by executing abnormality detection processing on a medical image via a computer in order to suppress overlooking of an abnormality by the image interpreter.

However, in a case in which the abnormality detection processing via the computer is uniformly performed on all the organs included in the medical image, a processing time increases. In addition, in this case, a large number of abnormalities may be presented to the image interpreter. As a result, an interpretation efficiency of the medical image decreases.

The present disclosure has been made in view of the above circumstances, and an object of the present disclosure is to provide an image processing apparatus, an image processing method, and an image processing program capable of suppressing a decrease in an interpretation efficiency of a medical image.

A first aspect provides an image processing apparatus comprising: at least one processor, in which the processor derives a degree of attention for each organ based on a content of a medical document, sets an execution condition of abnormality detection processing on a medical image according to the degree of attention for each organ, and executes the abnormality detection processing in accordance with the set execution condition.

A second aspect provides the image processing apparatus according to the first aspect, in which the processor derives the degree of attention based on a sentence described in at least one of a finding or a diagnosis result in the medical document.

A third aspect provides the image processing apparatus according to the second aspect, in which the processor derives the degree of attention based on at least one of an appearance frequency of a relevant word for each organ, an appearance frequency of a relevant sentence for each organ, the number of characters in the relevant sentence for each organ, or a degree of complexity of the relevant sentence for each organ.

A fourth aspect provides the image processing apparatus according to the second aspect, in which the processor derives the degree of attention by inputting at least a part of the medical document corresponding to a medical image of a diagnosis target to a trained model that receives at least a part of the medical document as an input and outputs the degree of attention, the trained model being trained using at least a part of a plurality of sets of the medical documents and the degree of attention, as learning data.

A fifth aspect provides the image processing apparatus according to any one of the first aspect to the fourth aspect, in which the processor executes the abnormality detection processing by inputting a medical image of a diagnosis target to a plurality of trained models that receive the medical image as an input and output region information representing an abnormal region of the medical image and a degree of certainty that the abnormal region is abnormal, the plurality of trained models being trained for each organ using a plurality of sets of the medical images, the region information, and the degree of certainty, as learning data, and the execution condition includes execution necessity of the abnormality detection processing for each organ, and a detection threshold value used for comparison with the degree of certainty.

A sixth aspect provides the image processing apparatus according to the fifth aspect, in which the processor sets the detection threshold value used for comparison with the degree of certainty output from the trained model corresponding to the organ to a larger value, as the degree of attention of the organ is higher.

A seventh aspect provides the image processing apparatus according to the fifth aspect or the sixth aspect, in which the processor does not execute the abnormality detection processing on an organ of which the degree of attention is equal to or more than a threshold value, and executes the abnormality detection processing on an organ of which the degree of attention is less than the threshold value.

An eighth aspect provides an image processing method executed by a processor included in an image processing apparatus, the method comprising: deriving a degree of attention for each organ based on a content of a medical document; setting an execution condition of abnormality detection processing on a medical image according to the degree of attention for each organ; and executing the abnormality detection processing in accordance with the set execution condition.

A ninth aspect provides an image processing program for causing a processor included in an image processing apparatus to execute: deriving a degree of attention for each organ based on a content of a medical document; setting an execution condition of abnormality detection processing on a medical image according to the degree of attention for each organ; and executing the abnormality detection processing in accordance with the set execution condition.

According to the aspects of the present disclosure, it is possible to suppress a decrease in an interpretation efficiency of a medical image.

### BRIEF DESCRIPTION OF THE DRAWINGS

FIG. 1 is a block diagram showing a schematic configuration of a medical information system.

FIG. 2 is a block diagram showing an example of a hardware configuration of an image processing apparatus.

FIG. 3 is a block diagram showing an example of a functional configuration of the image processing apparatus.

FIG. 4 is a diagram showing an example of a medical document.

FIG. 5 is a diagram for describing processing of setting an execution condition of abnormality detection processing.

FIG. 6 is a diagram for describing an example of a trained model.

FIG. 7 is a diagram for describing the abnormality detection processing.

FIG. 8 is a diagram showing an example of a display screen.

FIG. 9 is a diagram showing an example of a display screen.

FIG. 10 is a diagram showing an example of a display screen.

FIG. 11 is a flowchart showing an example of diagnosis support processing.

FIG. 12 is a diagram for describing a trained model according to a modification example.

### DETAILED DESCRIPTION

Hereinafter, examples of an embodiment for implementing the technique of the present disclosure will be described in detail with reference to the drawings.

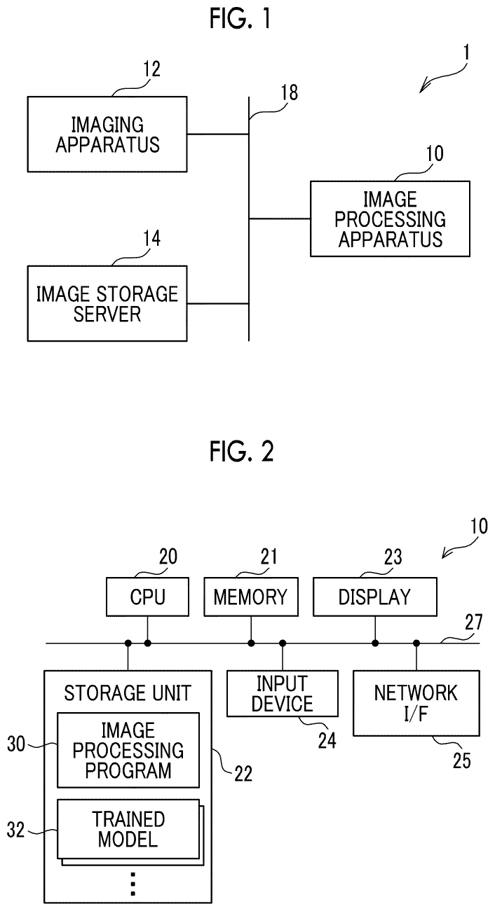

First, a configuration of a medical information system 1 according to the present embodiment will be described with reference to FIG. 1. As shown in FIG. 1, the medical information system 1 includes an image processing apparatus 10, an imaging apparatus 12, and an image storage server 14. The image processing apparatus 10, the imaging apparatus 12, and the image storage server 14 are connected to each other in a communicable manner via a wired or wireless network 18. The image processing apparatus 10 is, for example, a computer such as a personal computer or a server computer.

The imaging apparatus 12 is an apparatus that generates a medical image showing a diagnosis target part of a subject by imaging the part. Examples of the imaging apparatus 12 include a simple X-ray imaging apparatus, an endoscope apparatus, a computed tomography (CT) apparatus, a magnetic resonance imaging (MRI) apparatus, and a positron emission tomography (PET) apparatus. In the present embodiment, an example will be described in which the imaging apparatus 12 is a CT device and the diagnosis target part is an abdomen. That is, the imaging apparatus 12 according to the present embodiment generates a CT image of the abdomen of the subject as a three-dimensional medical image formed of a plurality of tomographic images. The medical image generated by the imaging apparatus 12 is transmitted to the image storage server 14 via the network 18 and stored by the image storage server 14.

The image storage server 14 is a computer that stores and manages various types of data, and comprises a large-capacity external storage device and database management software. The image storage server 14 receives the medical image generated by the imaging apparatus 12 via the network 18, and stores and manages the received medical image. A storage format of image data by the image storage server 14 and the communication with another device via the network 18 are based on a protocol such as digital imaging and communication in medicine (DICOM).

Next, a hardware configuration of the image processing apparatus 10 according to the present embodiment will be described with reference to FIG. 2. As shown in FIG. 2, the image processing apparatus 10 includes a central processing unit (CPU) 20, a memory 21 as a temporary storage region, and a non-volatile storage unit 22. In addition, the image processing apparatus 10 includes a display 23 such as a liquid crystal display, an input device 24 such as a keyboard and a mouse, and a network interface (I/F) 25 that is connected to the network 18. The CPU 20, the memory 21, the storage unit 22, the display 23, the input device 24, and the network I/F 25 are connected to a bus 27. The CPU 20 is an example of a processor according to the technique of the present disclosure.

The storage unit 22 is realized by a hard disk drive (HDD), a solid state drive (SSD), a flash memory, or the like. An image processing program 30 is stored in the storage unit 22 as a storage medium. The CPU 20 reads out the image processing program 30 from the storage unit 22, expands the image processing program 30 in the memory 21, and executes the expanded image processing program 30.

In addition, a plurality of trained models 32 are stored in the storage unit 22. Details of the trained model 32 will be described below.

The image processing apparatus 10 according to the present embodiment has a function of switching an execution condition of abnormality detection processing on a medical image based on a content of a medical document in order to suppress a decrease in an interpretation efficiency of the medical image. In the present embodiment, as the medical document, an example will be described in which an interpretation report created by an image interpreter such as a doctor who interprets a medical image of a diagnosis target (hereinafter, referred to as a “diagnosis target image”) is applied. In the following description, it is assumed that the diagnosis target image and a medical document created for the diagnosis target image are stored in the image processing apparatus 10.

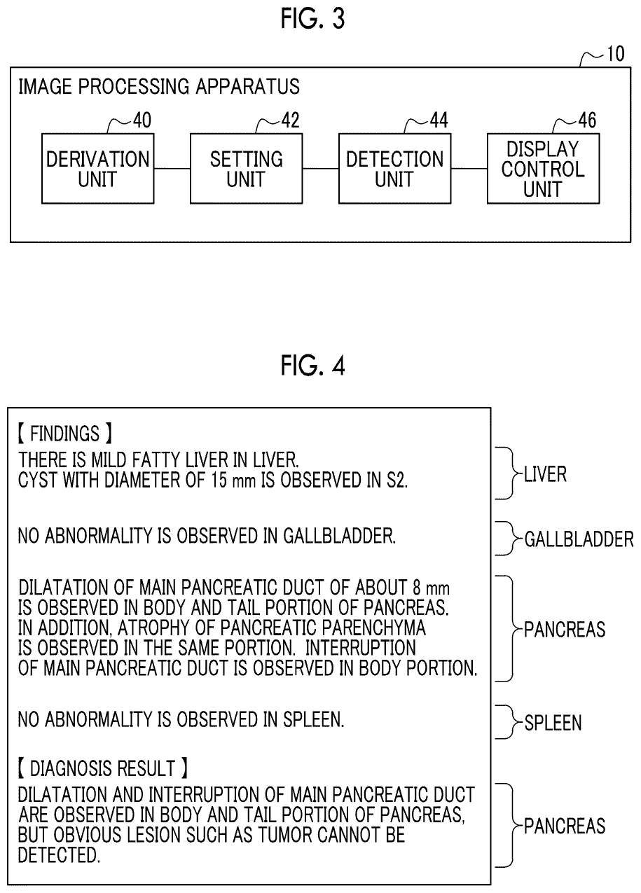

Next, a functional configuration of the image processing apparatus 10 according to the present embodiment will be described with reference to FIG. 3. As shown in FIG. 3, the image processing apparatus 10 includes a derivation unit 40, a setting unit 42, a detection unit 44, and a display control unit 46. The CPU 20 executes the image processing program 30 to function as the derivation unit 40, the setting unit 42, the detection unit 44, and the display control unit 46.

The derivation unit 40 derives a degree of attention for each organ based on the content of the medical document. As an example, as shown in FIG. 4, the medical document according to the present embodiment is provided with a field in which the image interpreter describes findings and a field in which the image interpreter describes a diagnosis result. In the example of FIG. 4, in the field of the findings, a sentence representing findings regarding each of a liver, a gallbladder, a pancreas, and a spleen is described, and in the field of the diagnosis result, a sentence representing a diagnosis result regarding the pancreas is described. In some cases, the medical document contains an organ that has not been described in the first place. In the example of FIG. 4, findings about a kidney are not described in the field of the findings.

The derivation unit 40 according to the present embodiment derives a degree of attention for each organ based on the sentence described in the findings and the diagnosis result in the medical document. The derivation unit 40 may derive the degree of attention for each organ based on any one of the findings or the diagnosis result in the medical document. Specifically, the derivation unit 40 derives the degree of attention for each organ based on an appearance frequency of a relevant word for each organ, an appearance frequency of a relevant sentence for each organ, the number of characters in the relevant sentence for each organ, and a degree of complexity of the relevant sentence for each organ in the sentence described in the medical document. The derivation unit 40 may derive the degree of attention for each organ based on one, two, or three of the appearance frequency of the relevant word for each organ, the appearance frequency of the relevant sentence for each organ, the number of characters in the relevant sentence for each organ, and the degree of complexity of the relevant sentence for each organ.

For example, the derivation unit 40 derives the degree of attention of the organ to be higher as the appearance frequency of the relevant word of the organ is higher. In addition, for example, the derivation unit 40 derives the degree of attention of the organ to be higher as the appearance frequency of the relevant sentence of the organ is higher. In addition, for example, the derivation unit 40 derives the degree of attention of the organ to be higher as the number of characters of the relevant sentence of the organ is larger. In addition, for example, the derivation unit 40 derives the degree of attention of the organ to be higher as the degree of complexity of the relevant sentence of the organ is higher. The relevant sentence of the organ is, for example, a sentence including the relevant word of the organ. In addition, the degree of complexity of the relevant sentence is derived based on, for example, a concatenation number of the auxiliary words in the sentence and an appearance frequency of the auxiliary words. The relevant word for each organ is, for example, defined in advance for each organ.

In the example of the medical document shown in FIG. 4, the derivation unit 40 derives the degree of attention of the liver and the pancreas as “high”, derives the degree of attention of the gallbladder and the spleen as “medium”, and derives the degree of attention of the kidney as low”. The degree of attention is not limited to three stages, may be two stages, and may be four stages or more. In addition, the degree of attention may be a numerical value.

In addition, for example, the derivation unit 40 may derive the degree of attention for each organ based on a degree of similarity between a sentence regarding each organ in the medical document to be processed and a sentence regarding each organ in another medical document. In this case, the derivation unit 40 considers that the lower the degree of similarity, the higher the specificity, and derives the degree of attention to be higher.

The setting unit 42 sets an execution condition of the abnormality detection processing on the diagnosis target image according to the degree of attention for each organ derived by the derivation unit 40. The setting unit 42 according to the present embodiment sets a threshold value (hereinafter, referred to as a “detection threshold value”) used for comparison with a degree of certainty output from a trained model 32, which will be described below, for each organ, as the execution condition of the abnormality detection processing. Specifically, the setting unit 42 sets the detection threshold value used for comparison with the degree of certainty output from the trained model 32 corresponding to the organ to a larger value, as the degree of attention of the organ is higher.

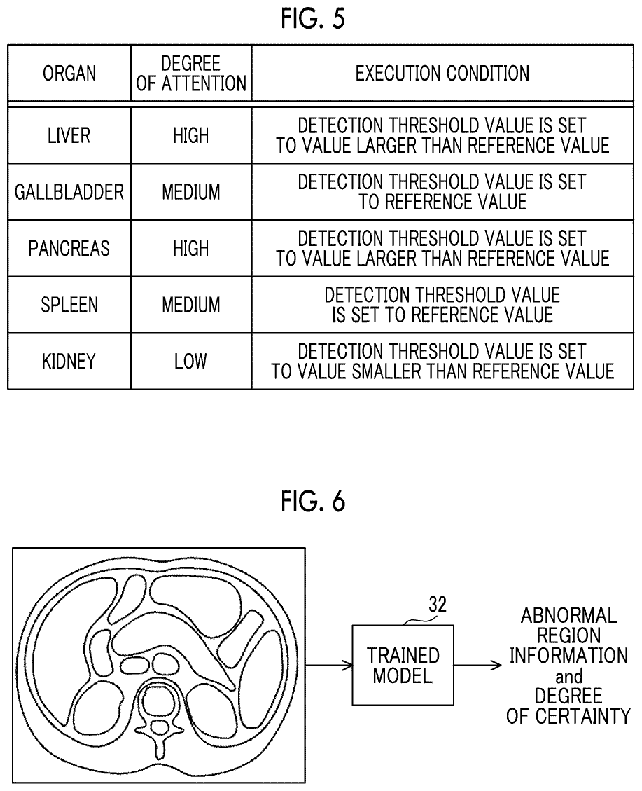

In the example of the medical document shown in FIG. 4, as shown in FIG. 5, the setting unit 42 sets the detection threshold value to a predetermined reference value for the gallbladder and the spleen of which the degree of attention is “medium”. In addition, the setting unit 42 sets the detection threshold value to a value larger than the reference value for the liver and the pancreas of which the degree of attention is “high”. In addition, the setting unit 42 sets the detection threshold value to a value smaller than the reference value for the kidney of which the degree of attention is “low”.

In addition, in the present embodiment, the setting unit 42 sets execution necessity of the abnormality detection processing for each organ, as the execution condition for each organ. In addition, for example, the setting unit 42 may set that the execution of the abnormality detection processing is not required for an organ of which the degree of attention is equal to or more than the threshold value (for example, “high”), and may set that the execution of the abnormality detection processing is required for an organ of which the degree of attention is less than the threshold value.

The detection unit 44 uses the diagnosis target image and the plurality of trained models 32 to execute the abnormality detection processing in accordance with the execution condition set by the setting unit 42. As an example, as shown in FIG. 6, the trained model 32 is a trained model that receives a medical image as an input and outputs region information (hereinafter, referred to as “abnormal region information”) representing a region having an abnormality (hereinafter, referred to as a “abnormal region”) in the input medical image and a degree of certainty that the abnormal region is abnormal.

The abnormality to be detected by the abnormality detection processing in the present embodiment includes a lesion to be directly treated, such as a cancer, a cyst, and inflammation. In addition, the abnormality to be detected includes a portion where at least one of the shape or the property generated in a periphery of the lesion is abnormal, in addition to the lesion. This abnormal portion is also referred to as indirect findings. For example, examples of the indirect findings suspected to be a pancreatic cancer include a shape abnormality such as partial atrophy and swelling in the pancreas. In addition, the abnormal region information need only be information capable of specifying the abnormal region in the medical image, and may be information representing a voxel position of the abnormal region in the medical image or an image in which the abnormal region in the medical image is filled with a preset color, for example. The degree of certainty is, for example, a numerical value equal to or more than a lower limit value and equal to or less than an upper limit value, and the larger the value, the higher the degree of certainty. The trained model 32 is configured by, for example, a convolutional neural network (CNN).

In addition, the trained model 32 is a trained model 32 that is trained for each organ using a plurality of sets of the medical images, the abnormal region information, and the degree of certainty as learning data. That is, the trained model 32 is obtained in advance through machine learning for each organ, such as “for liver” and “for pancreas”, and is stored in the storage unit 22.

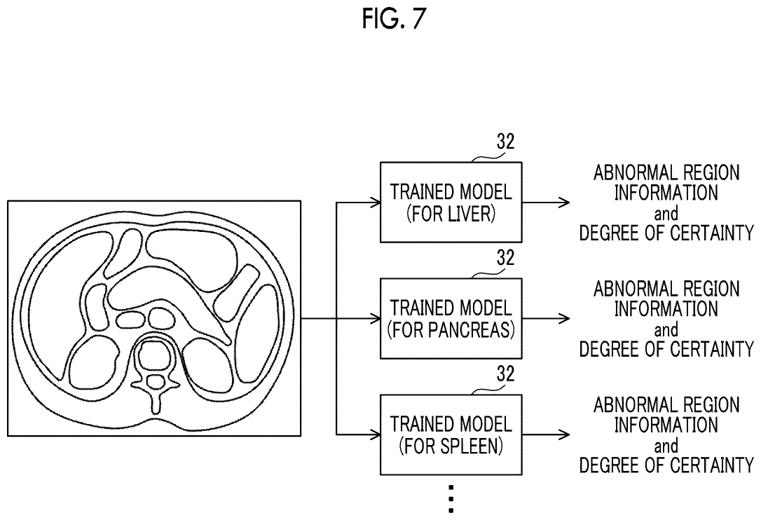

As shown in FIG. 7, the detection unit 44 inputs the diagnosis target image to the plurality of trained models 32 that is trained for each organ. Each trained model 32 outputs abnormal region information and a degree of certainty for each organ. The detection unit 44 detects abnormal region information whose degree of certainty is equal to or more than the detection threshold value. As described above, the detection threshold value is set by the setting unit 42 according to the degree of attention for each organ. In this way, the detection unit 44 executes the abnormality detection processing. The detection unit 44 may input a partial image obtained by cutting out a portion of the organ corresponding to the trained model 32 in the diagnosis target image, to the trained model 32 for each organ.

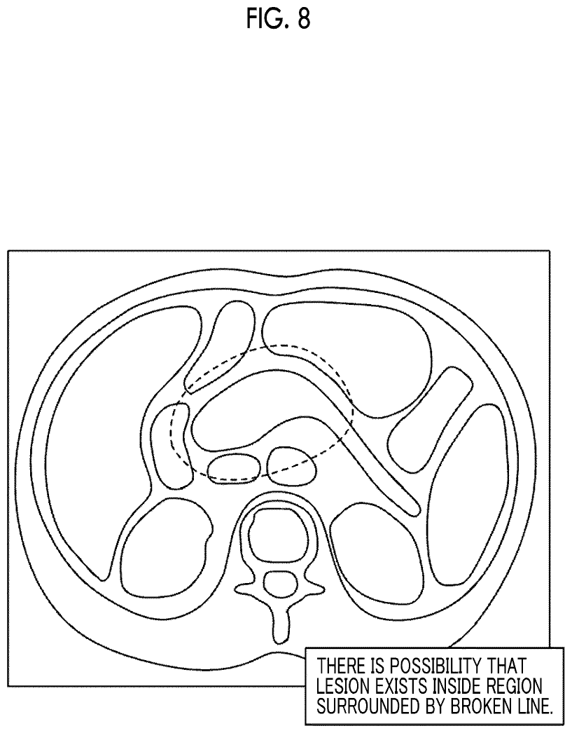

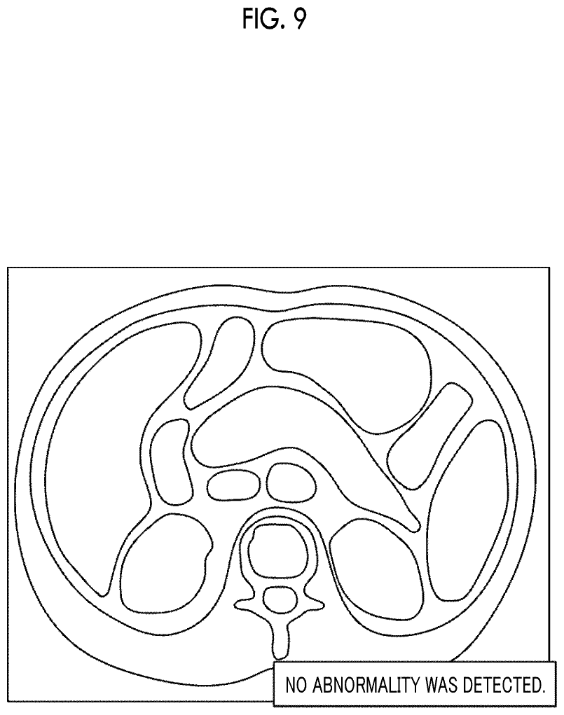

The display control unit 46 performs control of displaying an execution result of the abnormality detection processing by the detection unit 44 on the display 23. As an example, as shown in FIG. 8, in a case in which the detection unit 44 detects the abnormal region information whose degree of certainty is equal to or more than the detection threshold value, the display control unit 46 performs control of displaying, on the display 23, the diagnosis target image, an abnormal region indicated by the abnormal region information, and a message indicating that an abnormality exists, as the execution result of the abnormality detection processing. FIG. 8 shows an example in which a region inside a broken line is detected as the abnormal region by the abnormality detection processing.

In addition, as an example, as shown in FIG. 9, in a case in which the detection unit 44 does not detect the abnormal region information whose degree of certainty is equal to or more than the detection threshold value, the display control unit 46 performs control of displaying, on the display 23, the diagnosis target image and a message indicating that no abnormality has been detected, as the execution result of the abnormality detection processing.

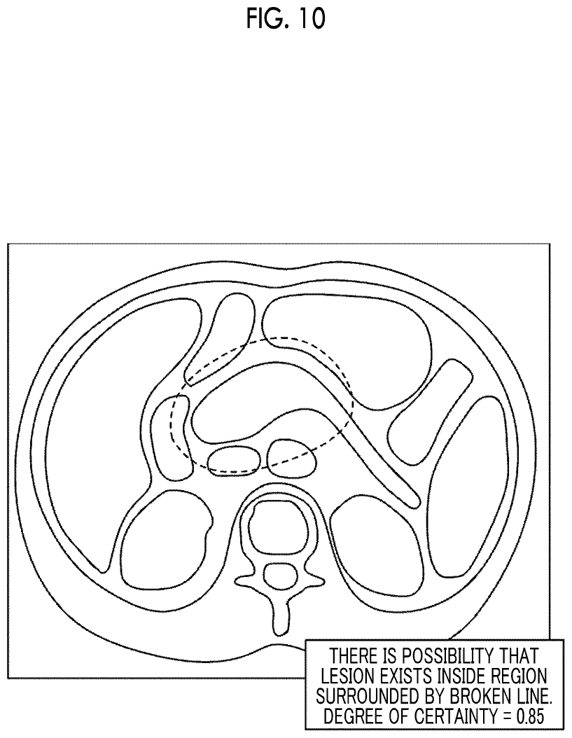

As shown in FIG. 10, further, the display control unit 46 may perform control of displaying the degree of certainty on the display 23 as the execution result of the abnormality detection processing.

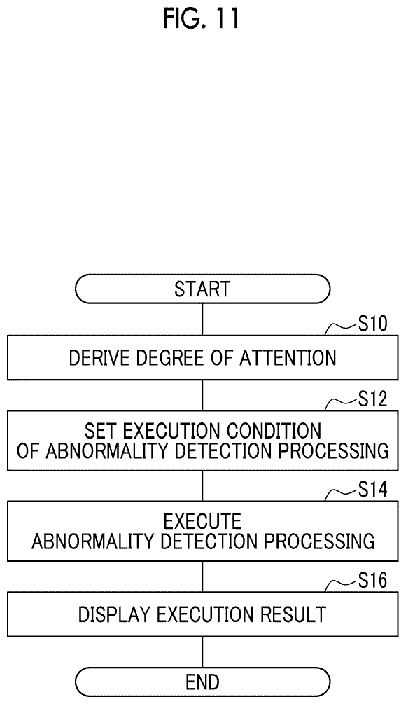

Next, an operation of the image processing apparatus 10 according to the present embodiment will be described with reference to FIG. 11. The CPU 20 executes the image processing program 30 to execute diagnosis support processing shown in FIG. 11. The diagnosis support processing shown in FIG. 11 is executed, for example, in a case in which an instruction to start an execution is input by a user.

In step S10 of FIG. 11, as described above, the derivation unit 40 derives the degree of attention for each organ based on the content of the medical document. In step S12, as described above, the setting unit 42 sets the execution condition of the abnormality detection processing on the diagnosis target image according to the degree of attention for each organ derived in step S10.

In step S14, as described above, the detection unit 44 executes the abnormality detection processing in accordance with the execution condition set in step S12 using the diagnosis target image and the plurality of trained models 32. In step S16, as described above, the display control unit 46 performs control of displaying, on the display 23, the execution result of the abnormality detection processing in step S16. In a case in which the process of step S16 ends, the diagnosis support processing ends.

As described above, according to the present embodiment, the execution condition of the abnormality detection processing on the diagnosis target image is set according to the degree of attention for each organ. Specifically, in the present embodiment, the higher the degree of attention of the organ, the larger the detection threshold value of the abnormality detection processing of the organ. That is, for the organ that the image interpreter does not pay attention to at the time of interpreting the diagnosis target image, more candidates of the abnormality are detected and presented to the image interpreter. Thereby, it is possible to suppress overlooking of an abnormality by the image interpreter. In addition, for the organ that the image interpreter pays attention to at the time of interpreting the diagnosis target image, the number of candidates of an abnormality presented to the image interpreter is relatively small. According, it is possible to suppress a decrease in an interpretation efficiency of the medical image.

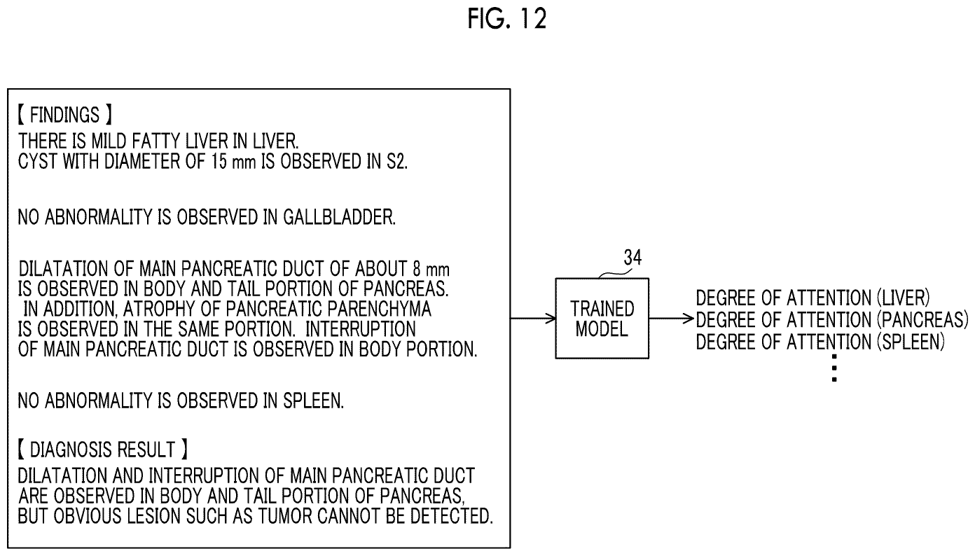

In the embodiment, a case has been described in which the derivation unit 40 derives the degree of attention for each organ based on the appearance frequency of the relevant word for each organ, the appearance frequency of the relevant sentence for each organ, the number of characters in the relevant sentence for each organ, and the degree of complexity of the relevant sentence for each organ in the sentence described in the medical document, but the present invention is not limited to this. As an example, as shown in FIG. 12, a form may be adopted in which the derivation unit 40 may derive the degree of attention for each organ by using the trained model 34 for deriving the degree of attention for each organ based on a medical document.

The trained model 34 in this form example is a trained model that receives a medical document as an input and outputs a degree of attention for each organ, the trained model being trained using a plurality of sets of the medical documents and the degree of attention for each organ as learning data. The trained model 34 is configured by, for example, a recurrent neural network (RNN). The derivation unit 40 inputs the medical document corresponding to the diagnosis target image to the trained model 34. The trained model 34 outputs the degree of attention for each organ based on the medical document. Thereby, the derivation unit 40 derives the degree of attention for each organ. In this form example, the derivation unit 40 may remove a portion not related to the organ in the medical document and input only a part of the medical document, that is, a portion related to the organ, to the trained model 34.

In addition, the trained model 34 in this form example may be a plurality of trained models that are trained for each organ. In this case, the derivation unit 40 classifies a sentence described in the medical document by determining which organ the sentence is described about based on words or the like appearing in the sentence, and inputs the sentence to the trained model 34 corresponding to the classified organ. Thereby, the derivation unit 40 derives the degree of attention of the classified organ. In addition, for example, in a case in which an input field for characters in the medical document is divided for each organ, the derivation unit 40 may derive the degree of attention of the organ by inputting the sentence described in the input field, to the trained model 34 corresponding to the organ in the input field.

In the above embodiment, a case in which the trained model 32 is configured by the CNN has been described, but the present disclosure is not limited to this. The trained model 32 may be configured by a machine learning method other than the CNN.

In addition, in the embodiment, a case in which a CT image is applied as the diagnosis target image has been described, but the present invention is not limited to this. As the diagnosis target image, a medical image other than the CT image, such as a radiation image captured by a simple X-ray imaging apparatus and an MRI image captured by an MRI apparatus, may be applied.

The processes in steps S10 to S14 of the diagnosis support processing according to the embodiment may be executed before an instruction to start an execution is input by the user. In this case, in a case in which the user inputs an instruction to start an execution, step S16 is executed, and the screen is displayed.

In the embodiment, for example, the following various processors can be used as a hardware structure of a processing unit executing various processes, such as the derivation unit 40, the setting unit 42, the detection unit 44, and the display control unit 46. The various processors include, as described above, in addition to a CPU, which is a general-purpose processor that functions as various processing units by executing software (program), a programmable logic device (PLD) that is a processor of which a circuit configuration may be changed after manufacture, such as a field programmable gate array (FPGA), and a dedicated electrical circuit which is a processor having a circuit configuration specially designed to execute specific processing, such as an application specific integrated circuit (ASIC).

One processing unit may be configured of one of the various processors, or may be configured of a combination of the same or different kinds of two or more processors (for example, a combination of a plurality of FPGAs or a combination of the CPU and the FPGA). In addition, a plurality of processing units may be configured of one processor.

As an example in which a plurality of processing units are configured of one processor, first, as typified by a computer such as a client or a server, there is an aspect in which one processor is configured of a combination of one or more CPUs and software, and this processor functions as a plurality of processing units. Second, as typified by a system on chip (SoC) or the like, there is an aspect in which a processor that implements functions of the entire system including the plurality of processing units via one integrated circuit (IC) chip is used. As described above, various processing units are configured by using one or more of the various processors as a hardware structure.

Further, as the hardware structure of the various processors, more specifically, an electric circuit (circuitry) in which circuit elements such as semiconductor elements are combined may be used.

In the embodiment, an aspect has been described in which the image processing program 30 is stored (installed) in the storage unit 22 in advance, but the present invention is not limited to this. The image processing program 30 may be provided in an aspect in which the image processing program 30 is recorded in a recording medium, such as a compact disc read only memory (CD-ROM), a digital versatile disc read only memory (DVD-ROM), and a universal serial bus (USB) memory. In addition, the image processing program 30 may be downloaded from an external device via a network.

What is claimed is:

1. An image processing apparatus comprising:
at least one processor,
wherein the processor
derives a degree of attention for each organ based on a content of a medical document,
sets an execution condition of abnormality detection processing on a medical image according to the degree of attention for each organ, and
executes the abnormality detection processing in accordance with the set execution condition.

2. The image processing apparatus according to claim 1,
wherein the processor derives the degree of attention based on a sentence described in at least one of a finding or a diagnosis result in the medical document.

3. The image processing apparatus according to claim 2,
wherein the processor derives the degree of attention based on at least one of an appearance frequency of a relevant word for each organ, an appearance frequency of a relevant sentence for each organ, the number of characters in the relevant sentence for each organ, or a degree of complexity of the relevant sentence for each organ.

4. The image processing apparatus according to claim 2,
wherein the processor derives the degree of attention by inputting at least a part of the medical document corresponding to a medical image of a diagnosis target to a trained model that receives at least a part of the medical document as an input and outputs the degree of attention, the trained model being trained using at least a part of a plurality of sets of the medical documents and the degree of attention, as learning data.

5. The image processing apparatus according to claim 1,
wherein the processor executes the abnormality detection processing by inputting a medical image of a diagnosis target to a plurality of trained models that receive the medical image as an input and output region information representing an abnormal region of the medical image and a degree of certainty that the abnormal region is abnormal, the plurality of trained models being trained for each organ using a plurality of sets of the medical images, the region information, and the degree of certainty, as learning data, and
the execution condition includes execution necessity of the abnormality detection processing for each organ, and a detection threshold value used for comparison with the degree of certainty.

6. The image processing apparatus according to claim 5,
wherein the processor sets the detection threshold value used for comparison with the degree of certainty output from the trained model corresponding to the organ to a larger value, as the degree of attention of the organ is higher.

7. The image processing apparatus according to claim 5,
wherein the processor
does not execute the abnormality detection processing on an organ of which the degree of attention is equal to or more than a threshold value, and
executes the abnormality detection processing on an organ of which the degree of attention is less than the threshold value.

8. An image processing method executed by a processor included in an image processing apparatus, the method comprising:
deriving a degree of attention for each organ based on a content of a medical document;
setting an execution condition of abnormality detection processing on a medical image according to the degree of attention for each organ; and
executing the abnormality detection processing in accordance with the set execution condition.

9. A non-transitory computer-readable storage medium storing an image processing program for causing a processor included in an image processing apparatus to execute:
deriving a degree of attention for each organ based on a content of a medical document;
setting an execution condition of abnormality detection processing on a medical image according to the degree of attention for each organ; and
executing the abnormality detection processing in accordance with the set execution condition.
